(19) United States
(12) Patent Application Publication
(10) Pub. No.: US 2026/0338233 A1
(43) Pub. Date: Oct. 29, 2026

(54) OMNI-DIRECTIONAL HIGH-CONDUCTIVITY SEGMENT RING IN ELASTICITY

(71) Applicant: VOOKEY NEW MATERIAL (SHANGHAI) CO., LTD., SHANGHAI (CN)

(72) Inventors: Huali WANG, SHANGHAI (CN); Benzhu GUO, SHANGHAI (CN); Yuhong SUN, SHANGHAI (CN); Yong ZHANG, SHANGHAI (CN)

(73) Assignee: VOOKEY NEW MATERIAL (SHANGHAI) CO., LTD., SHANGHAI (CN)

(21) Appl. No.: 18/851,134

(22) PCT Filed: Dec. 5, 2023
(86) PCT No.: PCT/CN2023/136310

§ 371 Date: Sep. 26, 2024

(30) Foreign Application Priority Data
Nov. 17, 2023 (CN) 202311535990.4

(51) Int. Cl. F16C 41/00; H02K 7/08; H02K 11/40

(52) U.S. Cl. CPC F16C 41/002; H02K 7/08; H02K 11/40

(57) ABSTRACT

An omni-directional high-conductivity segment ring in elasticity including an outer skeleton, a carrier ring, and an electric conduction assembly, wherein the electric conduction assembly includes an electric conduction ring, a plurality of lip edges, an electrically-conductive silicone adhesive having solidified from a liquid state, and an elastic part that adheres to said electrically-conductive silicone adhesive into integration. For the omni-directional high-conductivity segment ring in elasticity according to the present invention, it is possible to solve the problem that the corrosion to surrounding parts caused by the axial current generating from the EV electric motor rotating at a high rotation speed affects stability of operation states of attachments such as a bearing sleeved on the spindle, and then affects the stability, reliability, and safety of the electric motor under the conditions of high rotation speed, high power and high torque.

### FIELD OF THE INVENTION

The present invention relates to the technical field of electric motor attachments, in particular to an omni-directional high-conductivity segment ring in elasticity.

### BACKGROUND OF THE INVENTION

At present, there's been some fierce competition in the EV market, and “three electric installations” for EVs have been developed in rapid progress, and a number of EV companies have gradually increased their R&D investment in electric motors, batteries and electronic controls, among which the electric motors as the most important technology have become an object taken as a barrier and difficulty to be currently surmounted and overcome.

At present, an obstacle to EV motor technology consists in a limit to power, torque and speed of electric motors, and for the maximum power as reached currently, it is difficult to break through 400 KW, as well as for the maximum torque, it is difficult to break through 800 Nm. Among them, a technical difficulty that need to be broken through consists in stability, reliability and safety of motor spindles at a high rotation speed.

The existing problem that we have known is occurrence of axial currents to a motor spindle rotating at a high rotation speed due to static and dynamic friction of various stators and rotors inside an electric motor. In particular, an axial current occurring to a high-voltage 800V EV powertrain is especially obvious. The corrosion to surrounding parts caused by the axial current directly affects stability of an operation state of a bearing sleeved on the spindle, and then affects the stability of the electric motor under the conditions of high rotation speed, high power and high torque. The higher the power, the greater the axial current, and the severer a hazard is caused, so most electric machinery manufacturers have to set an upper limit for the power; in fact, it is possible to increase input power to raise the rotation speed of the electric motor, but the occurrence of the axial current also accelerates the wear and corrosion of the dynamic parts inside the electric motor, and directly cuts down the service life of the electric motor in half.

For this reason, in order to solve the problem of the axial current, a number of EV companies have deliberated, designed and demonstrated a variety of technical solutions, and one solution that may currently be adopted is that a metal brush is configured at the position of the bearing, so as to conduct away currents generated by a spindle at a high rotation speed, and release the currents. However, the actual effect of conducting away currents through the metal brush will be restricted by a water cooling means or an oil cooling means adopted in the electric motor, because the metal brush has to play a role only under the conditions of isolation from water or oil; moreover, the metal brush itself will also cause wear to the spindle, and the bigger a pressing force, the more it will affect the rotation speed of the spindle; in addition, the metal brush will also make the spindle heat up rapidly, resulting in a boost in internal heat of an entire motor powertrain, affecting heat exchange of the powertrain, and causing unstable operation conditions.

Therefore, for EV motor technology, or various technical fields that need to use electric motors, it is necessary to solve the problem how to release the axial current as soon as possible, and provide a technical solution that impossibly cause wear and corrosion to a rotating spindle, nor affect the water cooling means or the oil cooling means for an internal stator and rotor.

### SUMMARY OF THE INVENTION

An objective of the present invention is that in order to solve the problem that the corrosion to surrounding parts caused by the axial current generating from the electric motor rotating at a high rotation speed affects stability of operation states of attachments such as a bearing sleeved the spindle, and then affects the stability, reliability, and safety of the electric motor under the conditions of high rotation speed, high power and high torque, it is necessary to design an electric motor attachment that can rapidly conduct away and release the axial current, impossibly influences circulation of water or oil in a water cooling or oil cooling system, and applies a small radial force, which greatly reduces sliding friction and does not influence the rotation speed of the spindle, on the outer circumference of the spindle, meanwhile releasing the current in contact with the spindle, so as to effectively reduce the energy consumption of the electric motor, and ensure that the electric motor can operate stably and safely, so that it is possible to trustingly raise power to the electric motor, and then make the EV electric motor release higher speed, power and torque.

In order to solve the above technical problem, we provide the following technical solution.

An omni-directional high-conductivity segment ring in elasticity includes an outer skeleton made of a metal material, a carrier ring made a metal material, and an electric conduction assembly tightly pressed by the outer skeleton and the carrier ring, the electric conduction assembly includes an electric conduction ring, a plurality of lip edges arranged along a circumference of a spindle in a fan-shaped annular array, an electrically-conductive silicone adhesive having solidified from a liquid state so as to directly touch the circumference of the spindle, and an elastic part capable of conducting electricity that adheres to the electrically-conductive silicone adhesive into integration and moves in a radial direction of the spindle,
the electrically-conductive silicone adhesive is filled into the inside of the lip edge, which stabilizes a structure of the electrically-conductive silicone adhesive, and a current conducted from the spindle via the electrically-conductive silicone adhesive can be conducted to the electric conduction ring by the elastic part, and is released outwards by the electric conduction ring via the outer skeleton and/or the carrier ring,
the outer skeleton, the carrier ring and the electric conduction ring are all ring-shaped, and sleeved in clearance fit on a high-speed spindle, an electrically-conductive hole coordinated with the elastic part is opened on a circumferential surface of the lip edge, the elastic part penetrates through the electrically-conductive hole, and one end of the inside of the elastic part directly adheres to and touches the electrically-conductive silicone adhesive before solidifying from a liquid state filled inside a circulation groove of the lip edge, and is formed with the electrically-conductive silicone adhesive having solidified from a liquid state into integration,
one end of the outside of the elastic part penetrates through an adjusting hole arranged on the electric conduction ring,
an adjustable positioning pin is set between the elastic part and the electric conduction ring, the positioning pin is arranged in the adjusting hole, the positioning pin adjusts a pressure elastic force of the elastic part exerted on the electrically-conductive silicone adhesive in a radial direction of the spindle, and the positioning pin is capable of adapting to diameter sizes of various rotating spindles and adjusting a contact pressure force.

Preferably, an outer contour of the outer skeleton closely fits with a metal housing, an inner contour of the outer skeleton is interference fit with the carrier ring, enabling electrical conduction together, and conducting away a current to get released outwards.

Preferably, inner contours of the lip edge and the electrically-conductive silicone adhesive are all provided with a curved surface touching an outer contour of the spindle, and the curved surface touches the spindle and maintains a slight clamping force to keep electrical conduction.

Preferably, the lip edge is made of rubber or silicone.

Preferably, the elastic part is provided as a metal spring, and the lip edge and the electrically-conductive silicone adhesive can press radially on the outer circumference of the spindle under the elastic force of the metal spring, so as to keep electrical conduction, can bounce with bounces of the spindle in a radial direction, and can slightly move with slight movements of the spindle in an axial direction, even if the circumference of the spindle is coned, it is still possible to keep omni-directional stable contact and conduct the axial current.

Preferably, the elastic part is provided as a metal guiding rod, so as to raise discharge efficiency outwards via the electrically-conductive silicone adhesive, the metal guiding rod penetrates through a through hole at the middle of the positioning pin, and a spring is further sleeved on one end of the metal guiding rod toward the positioning pin, so that the metal guiding rod can slide in a radial direction.

The present invention has the following beneficial effects.

1. For the omni-directional high-conductivity segment ring in elasticity according to the present invention, it is possible to solve the problem that the corrosion to surrounding parts caused by the axial current generating from the EV electric motor rotating at a high rotation speed affects stability of operation states of attachments such as a bearing sleeved on the spindle, and then affects the stability, reliability, and safety of the electric motor under the conditions of high rotation speed, high power and high torque, and overcome a cutting-edge technical challenge from the electric motor's power having to be limited, that is a problem about the axial current that must be solved in a short time, otherwise there are potential safety hazards.

2. The plurality of fan-shaped lip edges used in the present invention can not only ensure good electrical contact with the spindle as well as a sufficient contact area, but also move synchronously in response to the radial or axial movement of the spindle, presenting an excellent performance of moving with the spindle, and ensuring a good performance of instantaneous electrical contact between the electrically-conductive silicone adhesive and the spindle.

3. The positioning pin matching the degree of tightness for screwing the elastic part is arranged in the electric conduction ring, so it is possible to freely adjust the strength of the electrically-conductive silicone adhesive enfolding the spindle, reduce the sliding friction of the lip edge and the electrically-conductive silicone adhesive with respect to the circumference of the spindle, lessen heat generation, decrease damping of electric motors, save electric energy, and prolong lasting time applied to electric vehicles.

4. The electrically-conductive silicone adhesive in a liquid state is used to make up for the defect as big resistivity of traditional electrically-conductive resin materials, so it is possible to increase the electrically-conductive contact area between the electric conduction ring and the inner skeleton, make it easier to conduct away the current, reduce the technical requirements for the electrically-conductive resin materials of the electric conduction ring, and reduce costs.

5. By the way of shortening the distance of electrical conduction between the electrically-conductive silicone adhesive having solidified from a liquid state and the spindle as much as possible, it is possible to rapidly conduct away and release the axial current, so that on generating the axial current, it can be immediately conducted outwards from the elastic part and released, improving the operation stability of electric motors at high power.

### BRIEF DESCRIPTION OF THE DRAWINGS

FIG. 1 shows a 3D view of the omni-directional high-conductivity segment ring in elasticity described in Example 1.

FIG. 2 shows a 3D view of the omni-directional high-conductivity segment ring in elasticity without the carrier ring described in Example 1.

FIG. 3 shows a 3D view of the omni-directional high-conductivity segment ring in elasticity without the carrier ring and the electric conduction ring described in Example 1.

FIG. 4 shows a partial section view of the omni-directional high-conductivity segment ring in elasticity described in Example 1.

FIG. 5 shows a section view at A-A in FIG. 4.

FIG. 6 shows a section view of the omni-directional high-conductivity segment ring in elasticity described in Example 2.

FIG. 7 shows a section view of the omni-directional high-conductivity segment ring in elasticity described in Example 3.

Where, 1—outer skeleton; 2—carrier ring; 3—lip edge; 4—electric conduction ring; 5—circulation groove; 6—metal spring; 7—curved surface; 9—positioning pin; 12—electrically-conductive silicone adhesive; 14—clearance; 15—electrically-conductive hole; 16—spindle; 17—metal guiding rod; 18—through hole.

### DETAILED DESCRIPTION OF SOME EMBODIMENTS

We shall clearly and completely describe the technical solution of the present invention by the way of presenting a plurality of embodiments in combination with the figures as follows.

### EXAMPLE 1

As shown in FIGS. 1-5, this example discloses an omni-directional high-conductivity segment ring in elasticity, which includes an outer skeleton 1 made of a metal material, a carrier ring 2 made a metal material, and an electric conduction assembly tightly pressed by the outer skeleton 1 and the carrier ring 2, the electric conduction assembly includes an electric conduction ring 4, eight lip edges 3 arranged along a circumference of a spindle 16 in a fan-shaped annular array, an electrically-conductive silicone adhesive 12 having solidified from a liquid state so as to directly touch the circumference of the spindle 16, and an metal spring 6 capable of conducting electricity that adheres to the electrically-conductive silicone adhesive into integration 12 and moves in a radial direction of the spindle 16.

As shown in FIGS. 4-5, the electrically-conductive silicone adhesive 12 is filled into the inside of the lip edge 3, which stabilizes a structure of the electrically-conductive silicone adhesive 12, and the current conducted from the spindle 16 via the electrically-conductive silicone adhesive 12 can be conducted to the electric conduction ring 4 by the metal spring 6, and is released outwards by the electric conduction ring 4 via the outer skeleton 1 and/or carrier ring 2.

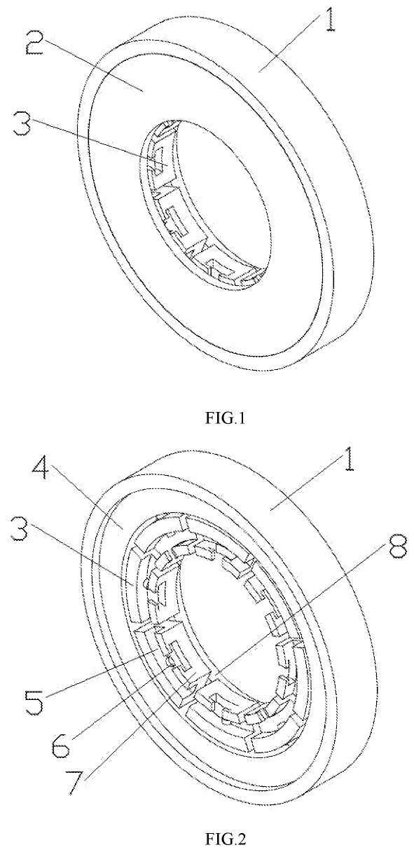

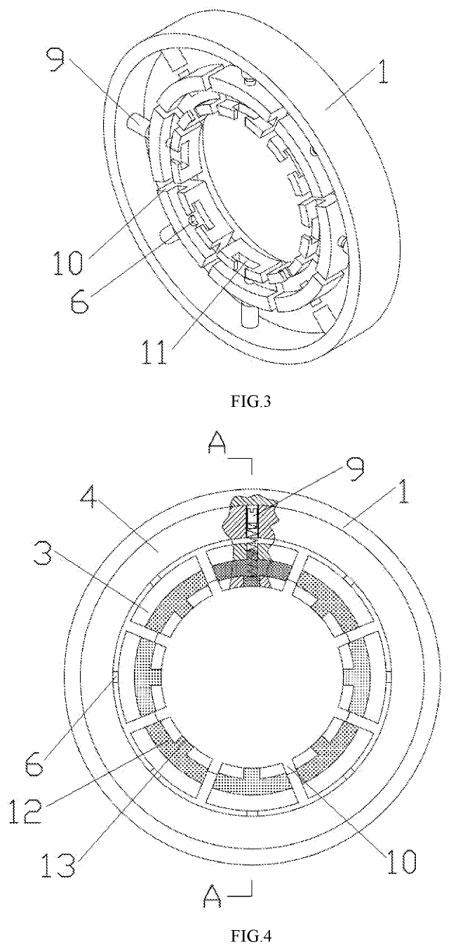

As shown in FIGS. 2-3, the outer skeleton 1, the carrier ring 2 and the electric conduction ring 4 are all ring-shaped, and sleeved on the high-speed spindle 16 by means of a clearance 14, an electrically-conductive hole 15 coordinated with the metal spring 6 is opened on a circumferential surface of the lip edge 3, the metal spring 6 penetrates through the electrically-conductive hole 15, and one end of the inside of the metal spring 6 directly adheres to and touches the electrically-conductive silicone adhesive 12 before solidifying from a liquid state filled inside a circulation groove 5 of the lip edge 3, and is formed with the electrically-conductive silicone adhesive 12 having solidified from a liquid state into integration.

As shown in FIG. 5, one end of the outside of the metal spring 6 penetrates through an adjusting hole arranged on the electric conduction ring 4, an adjustable positioning pin 9 is set between the metal spring 6 and the electric conduction ring 4, the positioning pin 9 is arranged in the adjusting hole in threaded connection, the positioning pin 9 adjusts a pressure elastic force of the metal spring 6 exerted on the electrically-conductive silicone adhesive 12 in a radial direction of the spindle, and the positioning pin 9 is capable of adapting to diameter sizes of various rotating spindles 16 and adjusting a contact pressure force.

As shown in FIG. 5, an outer contour of the outer skeleton 1 closely fits with a metal housing, an inner contour of the outer skeleton 1 is interference fit with the carrier ring 2, enabling electrical conduction together, and conducting away a current to get released outwards.

As shown in FIGS. 3 and 5, inner contours of the lip edge 3 and the electrically-conductive silicone adhesive 12 are all provided with a curved surface 7 touching an outer contour of the spindle 16, and the curved surface 7 touches the spindle 16 and maintains a slight clamping force to keep electrical conduction through a bigger contact area.

In a preferred example, the lip edge 3 is made of rubber or silicone.

In a preferred example, the lip edge 3 and the electrically-conductive silicone adhesive 12 can press radially on the outer circumference of the spindle 16 under the elastic force of the metal spring 6, so as to keep electrical conduction, can bounce with bounces of the spindle in a radial direction, and can slightly move with slight movements of the spindle 16 in an axial direction, even if the circumference of the spindle 16 is coned, it is still possible to keep omni-directional stable contact and conduct the axial current.

### EXAMPLE 2

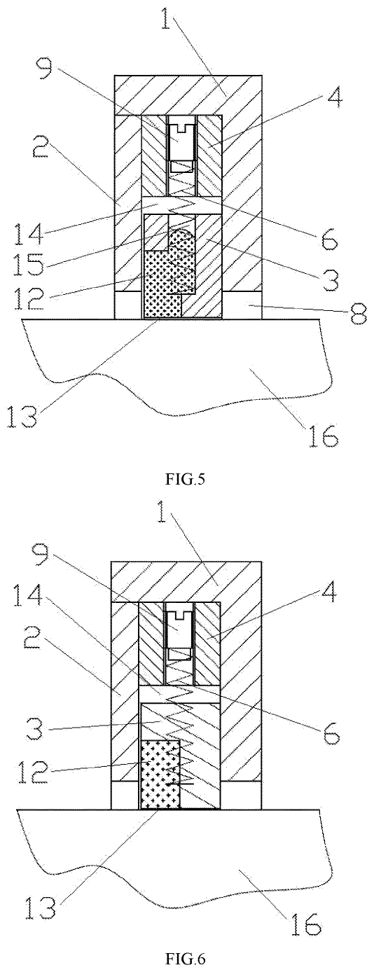

As shown in FIG. 6, this example discloses an omni-directional high-conductivity segment ring in elasticity, which includes an outer skeleton 1 made of a metal material, a carrier ring 2 made a metal material, and an electric conduction assembly tightly pressed by the outer skeleton 1 and the carrier ring 2, the electric conduction assembly includes an electric conduction ring 4, eight lip edges 3 arranged along a circumference of a spindle 16 in a fan-shaped annular array, an electrically-conductive silicone adhesive 12 having solidified from a liquid state so as to directly touch the circumference of the spindle 16, and an metal spring 6 capable of conducting electricity that adheres to the electrically-conductive silicone adhesive into integration 12 and moves in a radial direction of the spindle 16. Example 2 is deferent from Example 1 in that the circumferential surface of the lip edge 3 is formed with the metal spring 6 into integration, rather than provided with the electrically-conductive hole 15 coordinated with the metal spring 6, and one end of the inside of the metal spring 6 directly adheres to and touches the electrically-conductive silicone adhesive 12 before solidifying from a liquid state, and is formed with the electrically-conductive silicone adhesive 12 having solidified from a liquid state into integration. The advantage of this implementation is that: the metal spring 6 is more firmly connected with the structure of the lip edges 3, and one end of the inside of the metal spring 6 will not be integrally formed in the through hole as Example 1, so it is possible for the metal spring 6 to reduce the vibration caused by high-frequency bounce in a radial direction of the spindle, thus decreasing fragments generated from the electrically-conductive silicone adhesive 12 having solidified from a liquid state, and ensuring the stability and safety of the external environment of the rotating spindle 16 of the electric motor.

### EXAMPLE 3

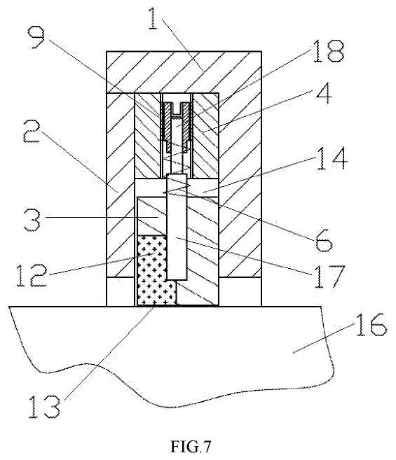

As shown in FIG. 7, this example discloses an omni-directional high-conductivity segment ring in elasticity, which includes an outer skeleton 1 made of a metal material, a carrier ring 2 made a metal material, and an electric conduction assembly tightly pressed by the outer skeleton 1 and the carrier ring 2, the electric conduction assembly includes an electric conduction ring 4, eight lip edges 3 arranged along a circumference of a spindle 16 in a fan-shaped annular array, an electrically-conductive silicone adhesive 12 having solidified from a liquid state so as to directly touch the circumference of the spindle 16, and an metal spring 6 capable of conducting electricity that adheres to the electrically-conductive silicone adhesive into integration 12 and moves in a radial direction of the spindle 16. Example 6 is deferent from Example 1 in that the elastic part is provided as a metal guiding rod 17, so as to raising discharge efficiency outwards via the electrically-conductive silicone adhesive 12, the metal guiding rod 17 penetrates through a through hole 18 at the middle of the positioning pin 9, and a spring is further sleeved on one end of the metal guiding rod 17 toward the positioning pin 9. The advantage of this implementation consists in ensuring that the metal guiding rod 17 can slide in a radial direction, and keep a pressure on the electrically-conductive silicone adhesive 12 and the electrically-conductive silicone adhesive 12 tightly enfolding the high-speed rotating spindle 16.

The embodiments of the present invention have been described in detail above in combination with the figures, but the present invention is not limited to the above-mentioned embodiments, and a person skilled in the art may also make various changes, modifications, substitutions and variants without departing from the objective of the present invention; in addition, the scope of the present invention is limited by the attached claims and their equivalents.

What is claimed is:

1. An omni-directional high-conductivity segment ring in elasticity comprising an outer skeleton made of a metal material, a carrier ring made a metal material, and an electric conduction assembly tightly pressed by said outer skeleton and said carrier ring, which are all ring-shaped, and sleeved in clearance fit on a spindle, wherein said electric conduction assembly includes an electric conduction ring, a plurality of lip edges arranged along a circumference of the spindle in a fan-shaped annular array, an electrically-conductive silicone adhesive having solidified from a liquid state so as to directly touch the circumference of the spindle, and an elastic part capable of conducting electricity that adheres to said electrically-conductive silicone adhesive into integration and moves in a radial direction of the spindle.

2. The omni-directional high-conductivity segment ring in elasticity according to claim 1, wherein said electrically-conductive silicone adhesive is filled into an inside of said lip edge, which stabilizes a structure of said electrically-conductive silicone adhesive, and a current conducted from the spindle via said electrically-conductive silicone adhesive can be conducted to said electric conduction ring by said elastic part, and is released outwards by said electric conduction ring via said outer skeleton and/or said carrier ring.

3. The omni-directional high-conductivity segment ring in elasticity according to claim 2, wherein inner contours of said lip edge and said electrically-conductive silicone adhesive are all provided with a curved surface touching an outer contour of the spindle, and the curved surface touches the spindle and maintains a slight clamping force to keep electrical conduction.

4. The omni-directional high-conductivity segment ring in elasticity according to claim 3, wherein an electrically-conductive hole coordinated with said elastic part is opened on a circumferential surface of said lip edge, said elastic part penetrates through said electrically-conductive hole, and one end of the inside of said elastic part directly adheres to and touches said electrically-conductive silicone adhesive before solidifying from a liquid state filled inside a circulation groove of said lip edge, and is formed with said electrically-conductive silicone adhesive having solidified from a liquid state into integration.

5. The omni-directional high-conductivity segment ring in elasticity according to claim 4, wherein one end of the outside of said elastic part penetrates through an adjusting hole arranged on said electric conduction ring.

6. The omni-directional high-conductivity segment ring in elasticity according to claim 5, wherein an adjustable positioning pin is set between said elastic part and said electric conduction ring, said positioning pin is arranged inside said adjusting hole, and said positioning pin adjusts a pressure elastic force of said elastic part exerted on said electrically-conductive silicone adhesive in a radial direction of the spindle.

7. The omni-directional high-conductivity segment ring in elasticity according to claim 4, wherein said elastic part is provided as a metal spring, and said lip edge and said electrically-conductive silicone adhesive can press radially on an outer circumference of the spindle under an elastic force of said metal spring, so as to keep electrical conduction.

8. The omni-directional high-conductivity segment ring in elasticity according to claim 4, wherein said elastic part is provided as a metal guiding rod, said metal guiding rod penetrates through a through hole at the middle of said positioning pin, and a spring is further sleeved on one end of said metal guiding rod toward said positioning pin.

9. The omni-directional high-conductivity segment ring in elasticity according to claim 1, wherein an outer contour of said outer skeleton closely fits with a metal housing, an inner contour of said outer skeleton is interference fit with said carrier ring, enabling electrical conduction together, and conducting away a current to get released outwards.
